(19) United States
(12) Patent Application Publication
(10) Pub. No.: US 2014/0312624 A1
(43) Pub. Date: Oct. 23, 2014

(54) TURBO-GENERATOR OF ELECTRICAL ENERGY

(71) Applicant: ARATEC ENGENHARIA CONSULTORIA E REPRESENTAÇÕES LTDA., Alphaville (BR)

(72) Inventor: Othon Luiz Pinheiro da Silva, Moema (BR)

(21) Appl. No.: 14/304,414

(22) Filed: Jun. 13, 2014

Related U.S. Application Data
(63) Continuation of application No. PCT/BR2012/000522, filed on Dec. 17, 2012.

(30) Foreign Application Priority Data
Dec. 15, 2011 (BR) PI1105123-0

(51) Int. Cl. F03B 13/10

(52) U.S. Cl. CPC F03B 13/10
USPC 290/52

(57) ABSTRACT

The present invention is an improvement in electrical energy turbo-generator, of a type employing an integrated set for generating electrical energy from a water-flow. The present invention includes a turbo-generator (1) comprises a modular arrangement to convert hydraulic energy into electrical energy whereof said arrangement is made by four integrated modules. Said integrated modules are: an inlet module (2), a generator (3) module, a distributor module (4), and an outlet module (5) interconnected by end flanges provided in each module and further by means of inlet bearing (M1) and outlet bearing (M2) disposed throughout a longitudinal shaft (E) playing a role of transmitting torque from upstream hydraulic turbine towards a generator rotor (7). Said generator rotor (7) supporting a permanent magnet crown-shaped piece, said generator rotor (7) actuating as an electromagnetic rotor; an additional conversion module (6) may be seldom provided.

### CROSS-REFERENCE TO RELATED APPLICATIONS

This application is a continuation of prior filed International Application No. PCT/BR2012/000522, as filed on Dec. 17, 2012, which claims priority to Brazilian Application No. PI1105123-0, as filed on Dec. 15, 2011. The contents of which are herein incorporated by reference.

### BACKGROUND OF THE INVENTION

1. Field of the Invention

The present invention is related to improvements in electrical energy turbo-generator;

more particularly, it is related to an arrangement in the construction of an electrical energy turbo-generator. Because of an adopted arrangement of pieces, this instant invention allows standardization in the design of turbo-generators for different waterfall heights up to thirty meters high in a way to reduce work-time and efforts required to a project.

The present invention also reduces manufacturing time and costs by simplifying the purchasing process with material suppliers and as well with the equipment assemblage steps. Additionally, the present invention decreases the construction and the installation costs of the machine in a hydroelectric plant because of the machine's reduced complexity in installation and in its auxiliary systems. The construction arrangement allows the use of the improved turbo-generator in water storage dam power plants or power plants without water storage dam, namely hydrokinetic power plants.

The present invention is advantageously used mainly in the following hydro conditions: peak, micro, mini, and small hydroelectric central power plants.

2. Technical Grounds

Hydraulic turbines are designed to change hydraulic energy from a water stream (pressure generated energy and kinetic energy) into mechanical energy (blades and shaft movements) and into electrical energy.

Use of a power generating plant depends on environmental and geographic conditions of certain regions. At first, possible energetic regional capacities have to be checked since each power plant requires special conditions to properly operate.

Hydraulic turbines are divided into three main types: Pelton, Francis, and Kaplan. Each type of turbine is adapted to run at power plants with a determined height range. Volume flows may be the same for any one of said turbines but the power will be based on to the water's falling height (product) (H) and on the volume flow (Q). This is the reason why there has to be a natural hydraulic unevenness or one created by a dam to capture and stream away the water towards the turbine, which is always located as low as possible so as to increase the mechanical energy of the water moving the turbine and producing electrical energy. Additionally, such an unevenness could be achieved by a water storage dam.

There are common operational principles for all of these types of turbines. Water runs into the turbine through a water inlet originating from a running river at a height greater than the power plant. Water is then conducted through a drawing conduit up to the entrance of turbine. The water runs through a system of fixed or movable guiding blades. Such blades are to control water volume flow supplied to the turbine. By controlling water flow and water direction reaching the hydraulic turbine rotor by means of adjusting position of turbine pre-distributor device, the power of the whole set may be controlled. After passing through such a mechanism, water reaches the hydraulic turbine rotor. Due to transfer of certain amount of movements, a part of hydraulic energy is transferred to the rotor in the form of torque and rotation speed.

As a matter of knowing, Pelton turbine is the one mostly used to operate with waterfalls higher than 70 meters with a somewhat smaller water-flow. This is the reason why it is commonly used in mountainous countries.

Francis turbine is mostly used to operate with waterfalls higher than 30 meters high with great water volumes. Francis turbines are used in Itaipu Hydro-electric Power Plants, Tucurui Power Plants, Furnas Power plants, and others.

As for Kaplan turbine, it is widely used to operate mainly with waterfalls lower than 30 meters high. The Kaplan turbine is similar to a ship propeller with two or six moveable blades. Amongst various types of Kaplan turbines, two variants are highlighted: a) driving turbines or propeller turbines and b) bulb turbines that have bulbs placed inside a submersed channel containing an encased generator and propelling blades.

Bulb turbines, an object of the present claimed improvements, operate with waterfalls lower than 30 meters high. They are designed to be installed to medium and small-sized hydraulic systems with a better efficiency in the energy conversion rate. This type of turbine is made of a generating piece comprising a Kaplan turbine and a generator encased in a capsule. The capsule remains immersed into the water-flow. This results in a piece of equipment, which requires a more precise sealing and consequently, has a smaller room to access for maintenance.

Because of the great quantity of rivers and tributaries and the considerable number of small isolated communities as well, mainly in those locations where low-income populations live and whereof electrical energy supply through conventional means are somewhat difficult to access, bulb turbines are possibly a social contribution.

Use of such turbines without the need of having fixed installations and coupled to floating apparatuses and yet using river streams (hydrokinetic) can provide electrical energy to small isolated systems mainly, those of poor populations located close to water streams in third world and developing countries.

BRIEF DESCRIPTION OF THE RELATED ART

A search at databank revealed a few patent documents related to the same field as the present invention; however, significant differences exist as compared to the claimed invention.

Brazilian document PI0502419-6 teaches an electrical energy generating device requiring reduced frequency simplified maintenance additionally to having useful application in several types of hydroelectric energy generating central power plants mainly peak, micro, mini and small central hydro-electric plants owing to construction design. Electrical energy is obtained from conversion elements comprising a hydroelectric turbine and a generator comprising a generator stator and a generator rotor.

Brazilian document PI0805515-7 (Electric Central Power Plant) taught a turbine designed with a diffusing device, a housing, an integrated conversing core, a turbine rotor, a securing ring and a securing clamp. Electrical energy is generated from fluid flow colliding against a rotor turning on a shaft coupled to an integrated conversing core. Said converting core is secured to said housing by a securing ring. This is a compact turbine used, for example, in natural river streams, which does not require construction of water storage dam and yet may be submersed in varying depth and varying size locations and able to generate energy even having flow speed variations and low water volume.

Document U.S. Pat. No. 4,289,971 taught a hydroelectric energy generator comprising a bulb turbine generator incased in a capsule. The generator room is coupled to an electrical energy generator main shaft. The external capsule is coupled to the housing by fixed blades.

### BRIEF SUMMARY OF THE INVENTION

After having reviewed the prior art and willing to overcome inconvenient aspects due to the existing art, said improvements in electrical energy turbo-generator were developed. Particularly applied to electrical energy generating systems. Improvements comprise a specific arrangement in which energy-converting elements comprise a set formed by four integrated modules (a-d below) and an additional possible module (e below). The modules include:

a) Inlet module wherein an outer tube first section and a water inlet hydrodynamic housing are installed;

b) Generator module wherein an outer tube second section, a bearing sealing cover, a generator module closing flange, a generator rotor, a generator module securing a reinforcing collar, a stator securing ring, a permanent magnets synchronous generator stator, a resistant material generator module housing, an outlet bearing and one or more electrical wire tubes and monitoring cables are installed. There are two concentric structures. In an inner concentric structure, a permanent magnet generator is disposed. Said encapsulated electric generator is operated with positive pressure relative to the circulating water between said two concentric structures and with its rotor either immersed or not, in an oil bed.

c) Distributor device module wherein an outer tube third section and a hydraulic turbine distributor are installed; and

d) Outlet module wherein an outer tube fourth section, a hydraulic turbine rotor and a water outlet housing are installed. Said water outlet housing is molded to avoid the slightest possible turbulence and charge loss when water is discharged back to river.

e) Conversion module: when the machine does not generate power from a network frequency, a generator set is provided with an outer module to convert frequency and to regulate tension.

All four integrated modules are united by a water tube outer portion existing flanges to avoid interruption of flowing water inside.

In this electricity hydro-generator, hydraulic energy conversion into mechanical energy takes place on a propeller or Kaplan turbine and mechanical energy conversion into electrical energy is made in an electrical generator. Said electrical generator rotor is directly coupled to a shaft connecting the electrical generator to a hydraulic turbine rotor. Said shaft may be made of a single piece or may be divided into interconnected sections connected by either flanges, reels, sleeves or the like.

An electrical generator has its permanent magnets rotor coupled to a shaft that connects said electrical generator to a Kaplan or a propeller hydraulic turbine. A stator with electrical coils is jointly assembled to a generator module housing thus allowing energy converting elements to comprise an integrated set formed by said four modules.

Preferred physical arrangement of electrical energy generating equipment provides a synchronous generator with permanent magnets disposed in the surface or close to the generator rotor surface.

Compound materials, resins, ceramics, or non-magnetic steel may be used to encapsulate rotor permanent magnets or to encapsulate electrical generator stator. Yet, encapsulation may be made with a combination of said materials.

Encapsulation with said materials may be done by whatever means such as injection, immersion, dripping or by some kind of application as by sheets, tapes, blankets and similar materials.

The existing physical room located inside the generator chamber may be filled with isolating oil or with an inert gas such as nitrogen.

The shaft connecting the hydraulic turbine rotor to the electrical generator rotor is a continuous rotor and maintained downstream by the inlet bearing and upstream by an outlet bearing. One of these two bearings plays the role of a supporting bearing. In the majority of such cases, this function is performed by an outlet bearing.

This invention is designed to minimize charge losses. The water is captured in an inlet section, runs around the inlet housing, close to the generator module housing inner tube, through said distributor device and when water starts circular movements it runs through a hydraulic turbine rotor. The water is then discharged back to the river while also acting as coolant to cool the generator stator.

### OBJECTIVES AND ADVANTAGES OF THE INVENTION

Assembling hydraulic turbine by means of modules allows a high level of standardization in the equipment, a significant reduction of installation costs in a hydro-electrical power plant of a type as a small central hydro-electrical plant, mini central hydro-electrical plant, micro central hydro-electrical plant and peak central hydro-electrical plant because the turbo-generator may be directly installed in a water storage dam as a single set or as a module-made set requiring a minimum of additional civil construction works.

The Kaplan or propeller type hydraulic turbine is directly connected to the permanent magnets synchronous generator rotor by means of a shaft made into a single piece or divided into sections not requiring speed reducing or speed increasing means such as reduction gears, a conveyor, a friction transmission, or any other type of said means.

The invention allows an optimized design of turbine/generator set by using a number of pole peers suitable for every application in such a way to obtain the best output for the turbine electrical generator jointly thus eliminating the use of gears or conveyors and pulleys for coupling means; thus ensuring a high output to hydro-generator.

Said discussed arrangement for said hydraulic turbine allows use of said turbine both for hydrokinetics and for hydro-generators to be used with waterfalls with around 30 meters high and when generators in a series are used in the same flow stream said same arrangement may be used with waterfalls higher than said 30 meters high.

Another advantage in such arrangement is found in that a variation may be used in the pole numbers or in the number of permanent magnets synchronous generators within the same module.

Said arrangements allow an operation without varying direction of water-flow (called straight-flow) since it may run horizontally or in any other inclination. The set architecture also avoids the use of a heat-sink.

### BRIEF DESCRIPTION OF THE DRAWINGS

In a way to complement this instant patent specification and to provide a better understanding of the features in the invention and in accordance with a preferred embodiment a full set of drawings go together with this specification whereof in a simplified manner, although not limiting, the following was illustrated.

FIG. 1 illustrates an outer perspective view of the improved electrical energy turbo-generator.

FIG. 2 illustrates a perspective partial cut-off view of the improved turbo-generator showing an inner portion in a complete view and the bulb housing.

FIG. 3 illustrates another partial cut-off view of the improved generator whole room.

FIG. 4 illustrates an exploded perspective view of the pieces comprising the improved turbo-generator.

FIG. 5 illustrates a turbine cut-off side view with turbine set assembled.

FIG. 6 illustrates both a cut-off side view and an exploded view showing all pieces comprising this instant hydraulic turbine.

FIGS. 7 and 7A respectively illustrate a central body frontal view and a back view.

FIGS. 8 and 8A respectively illustrate pre-distributor device frontal view and back view.

FIGS. 9 and 9A respectively illustrate hydraulic rotor set frontal view and back view.

### DETAILED DESCRIPTION OF THE PREFERRED EMBODIMENT

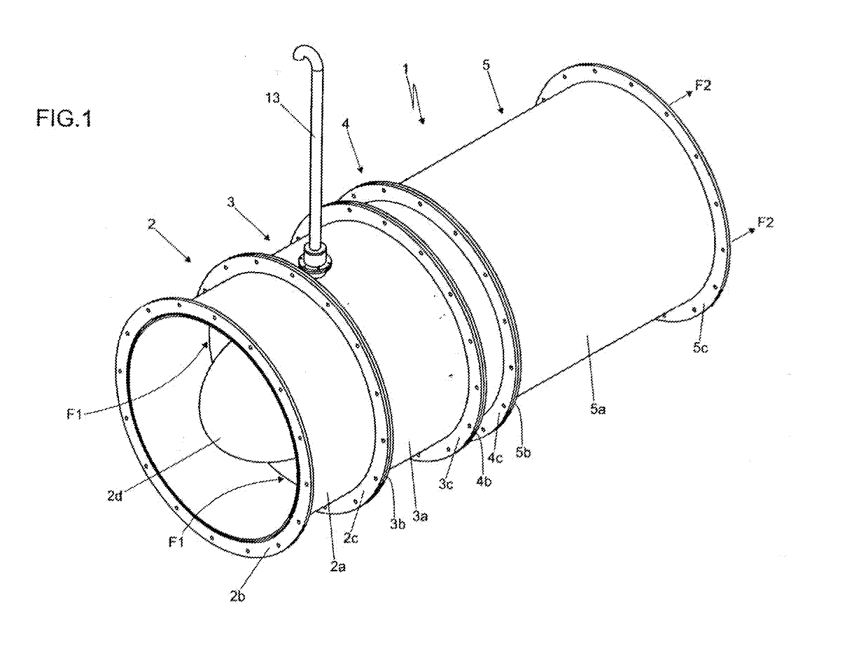

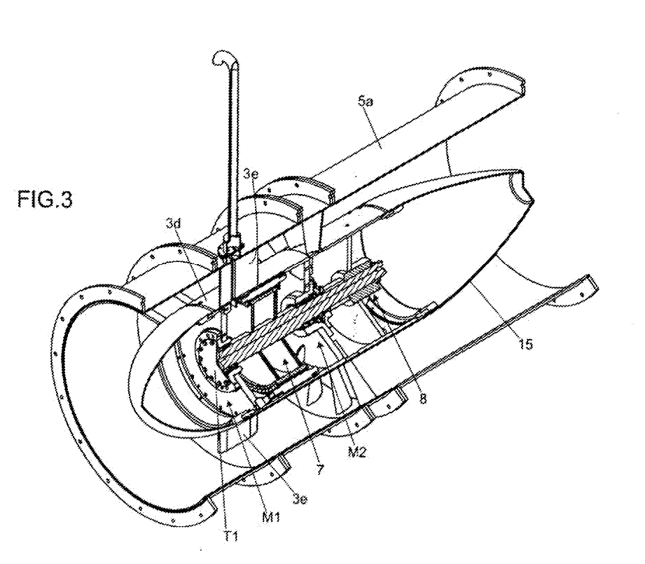

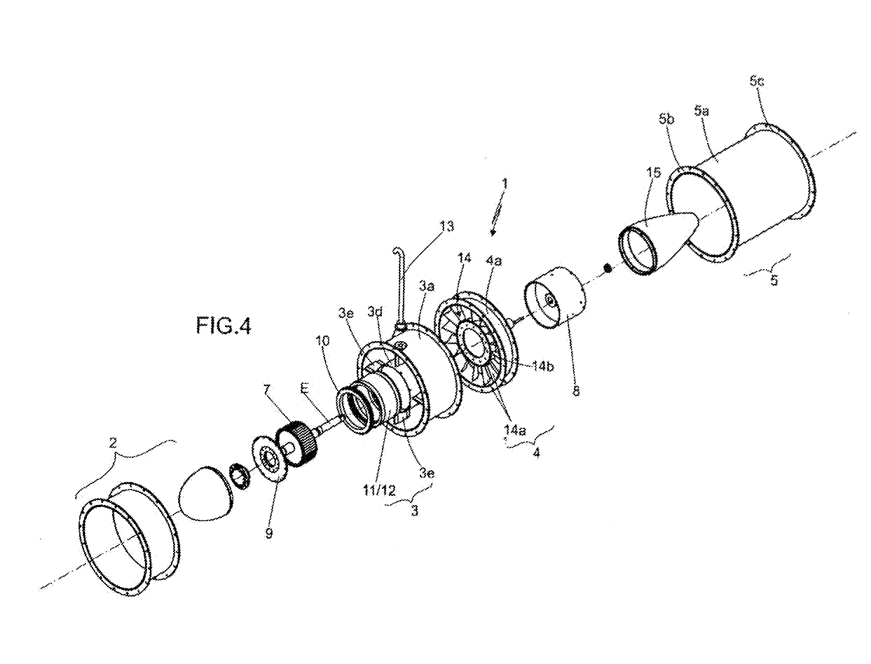

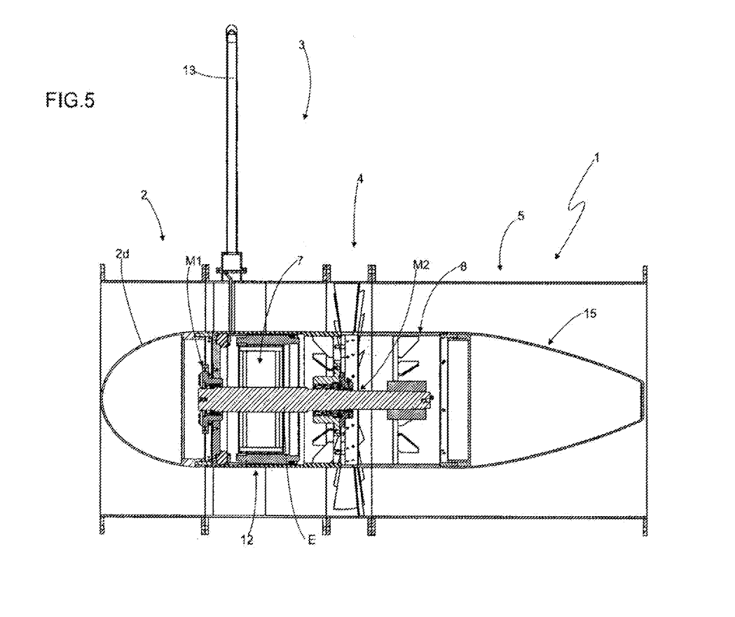

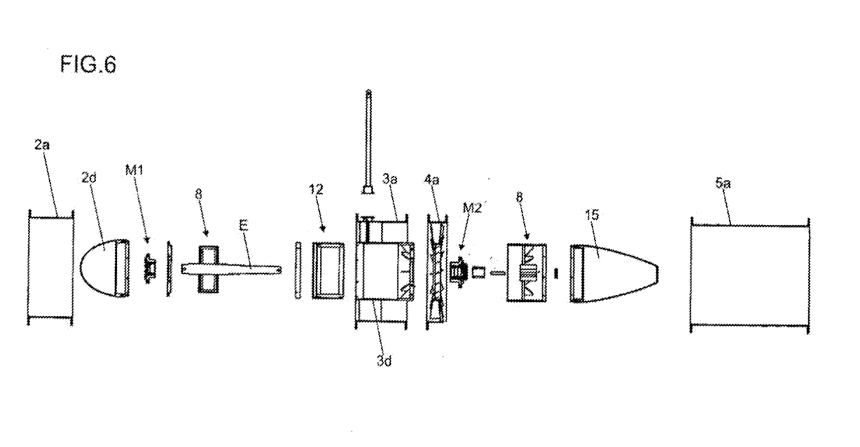

Referring to the illustrating drawings, this instant invention relates to improvements in an electrical energy turbo-generator of a type, which employs an integrated set to generate electrical energy starting from a water-flow. As shown in FIG. 1, said improved turbo-generator (1) comprises a specific arrangement in which energy-converting elements are made of a set formed by four integrated modules. Said modules are inlet module (2), generator module (3), distributor module (4), and outlet module (5). As shown in FIG. 3, by inlet bearing (M1) and outlet bearing (M2) said modules are assembled to a longitudinal shaft (E) (See FIG. 4) to transmit torque from hydraulic turbine upstream to the generator rotor supporting a permanent magnets crown-shaped piece in such a way to work as an electromagnetic rotor. Seldom an additional conversion module (6) may be provided.

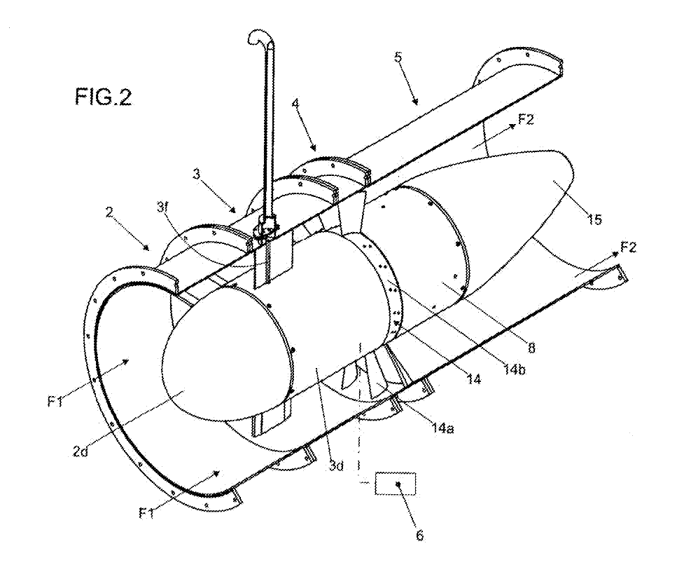

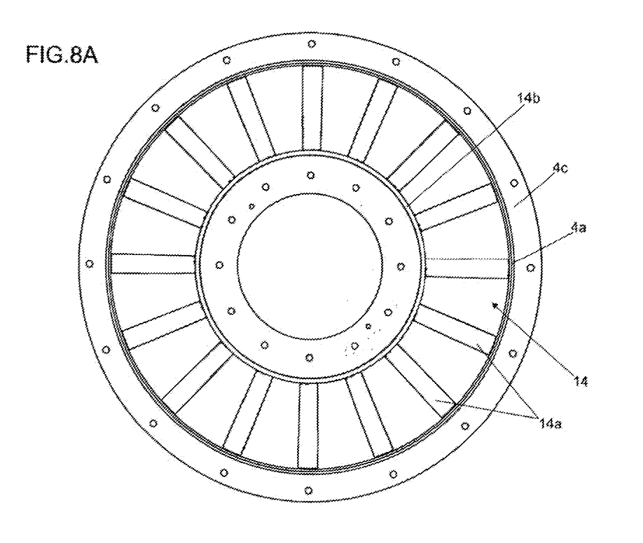

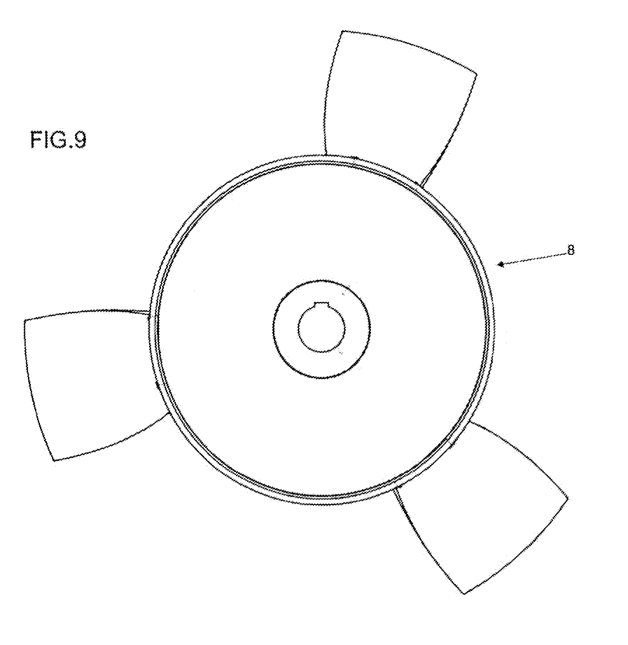

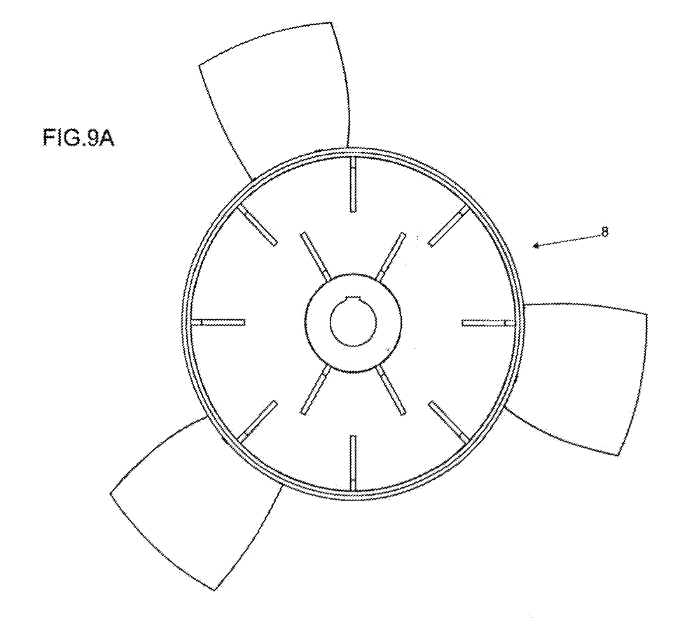

Outer tube first section and inlet water hydrodynamic housing are installed in the inlet module (2). Shown in FIG. 1, said outer tube comprises a wall (2a) and flanges (2b) (2c). Said hydrodynamic housing is ogive-shaped. Inlet module (2) is manufactured with a resistant material and plays the role of capturing water within certain hydrodynamic specifications obtained by said housing (2). Said housing is designed with resistant material and formatted to allow a water-flow (F1) to become generated with a minimum charge loss and a minimum turbulence as well and to run towards hydraulic turbine rotor (8) assembled in said shaft (E) (See FIGS. 2 and 8). Said shaft (E) may comprise a single piece or may be divided into sections inter-connected by flanges, reels, sleeves and the like.

As shown in FIGS. 5 and 6, an inlet bearing (M1) is provided between said inlet module (2) and said generator module (3) having the role of supporting the electromagnetic rotor set (7) downstream keeping said electromagnetic rotor set aligned with said assembled hydraulic rotor set (8) located upstream. Central portion of said bearing (M1) whereof shaft (E) end is assembled, is sealed by a sealing cover (T1) as illustrated in FIG. 3.

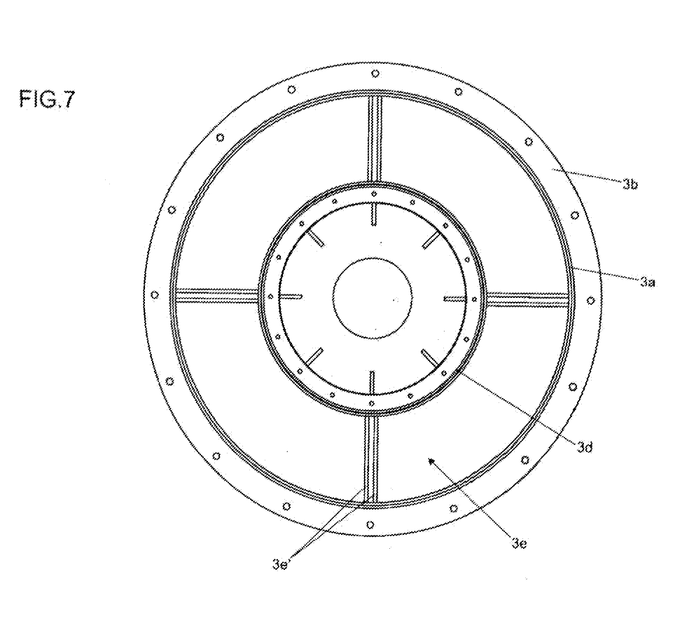

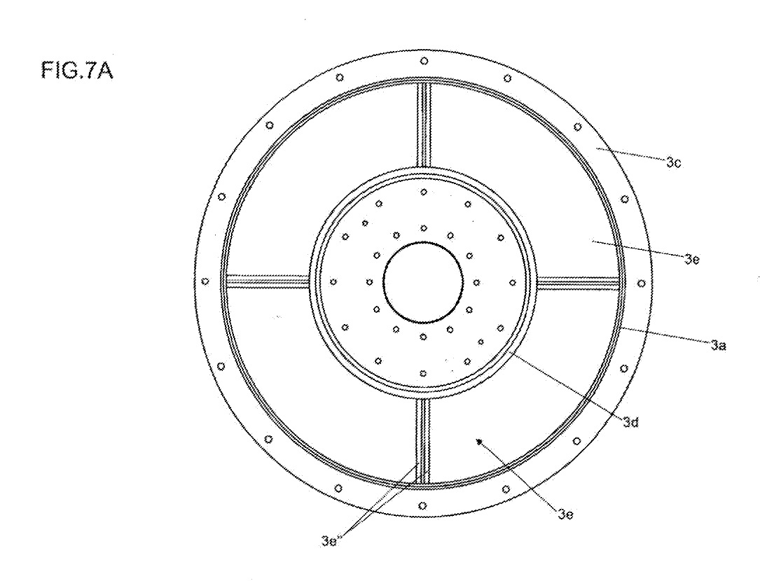

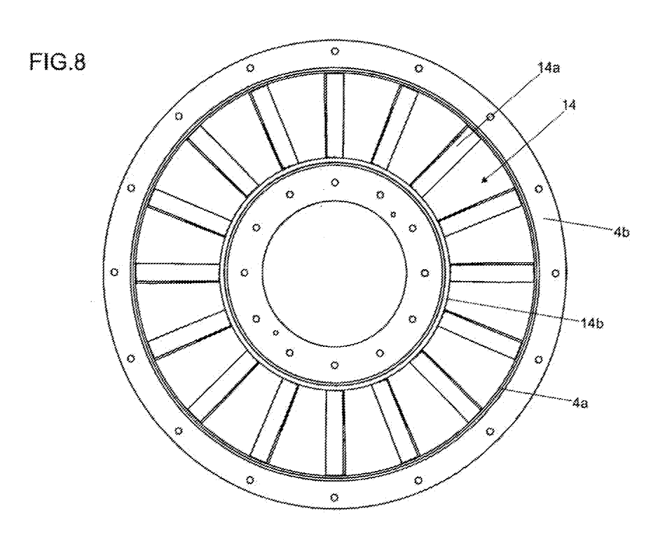

Shown in FIGS. 7-7A, generator module (3) comprises outer tube second section with a wall (3a) segment and flanges (3b) (3c) made of resistant material. A smaller diameter tube (3d) made of the same material as that of said tube (3a) is provided at an inner portion of said tube (3) and said smaller diameter tube (3d) is concentrically disposed thereof relative to said tube (3a) by means of structural winglets (3e). Said winglets are longitudinally disposed thereof having inlet grooves (3e′) and outlet grooves (3e″). Generator rotor (7), generator module (3) reinforcing and securing collar (9), stator securing ring (10), permanent magnets synchronous generator (12), and stator (11) are assembled in the interior of said tube (3d) as illustrated in FIG. 4. Permanent magnet poles are installed in said generator and said permanent magnet poles play the role of magnetizing said generator rotor (7) set.

Generator stator (11) is similar to stators usually utilized and comprises a magnetic circuit and a multiphase winding disposed within stator slots. Said magnetic circuit is named stator iron. As being somewhat peculiar, generator stator (11) is aimed at imparting desired characteristics to the generator outlet electric tension.

Two concentric structures (3a) (3d) maintain permanent magnets electrical generator (12) encapsulated and operating with positive pressure relative to the water running between said concentric structures and with said rotor (7) immersed or not into an oil bed.

As shown in FIG. 4, generator module (3) is provided with one or more tubes (13) for electrical wires and monitoring cables out of the module. Said tubes communicate with generator (12) by means of a channel (3f) made into one or more winglets (3e) as illustrated in FIG. 2.

Distributor module (4) comprises installation of turbine (1) third section (See FIG. 5). As shown in FIG. 8, Distributor module (4) is made of an outer tube (4a) with end flanges (4b) and (4c) and plays the role of allowing pre-distributor device (14) to be assembled in the hydraulic turbine. Said hydraulic turbine may have fixed or moveable blades depending on its application.

As shown in FIGS. 3, 5, and 6, an inlet bearing (M2) is assembled in said central portion of pre-distributor device (14) which plays the role of supporting said electromagnetic rotor (7) upstream side, which normally will be used as a supporting piece to support axial forces exerted on this portion of said shaft (E). Additionally, said bearing (M2) ensures alignment of said electromagnetic rotor (7) set with said hydraulic rotor (8) assembled set, which is used for fluid-dynamic energy conversion. Said hydraulic rotor (8) assembled set may be one of Kaplan or propeller type.

As shown in FIG. 4, outlet module (5) is a fourth section for installation and comprises an outer tube sector (5a) with end flanges (5b) and (5c) whereof said tube (5a) concentrically accommodates said hydraulic rotor (8) which outer diameter is compatible with pre-distributor device (14) central collar (14b) and also with water inlet housing diameter (15). Said housing is shaped in a way to ensure water is returning to its running course through an outlet flow (F2) with less possible turbulence and charge loss.

In said turbine (1), a conversion module (6) may be included as illustrated in FIG. 2. Said module is used when turbine does not generate power in the net frequency. In such case, said generator set (12) will be provided with an outer module for frequency conversion and tension regulation. Said outer conversion module may be located distant from said hydro-generator in a protected site to resist weather conditions.

It is certain that when the present invention is put under practice modifications might be introduced in the matter referred to certain design details and form, however without departing from the basic principles that are clearly based in the claims set and thus it is understood that the terminology herein employed has no intent to limit this invention.

What is claimed is:

1. Improvements in electrical energy turbo-generator of a type that employs an integrated set to generate electrical energy from a water-flow characterized in that the turbo-generator (1) comprises a modular arrangement for conversion of hydraulic energy into electrical energy whereof said arrangement is made of four integrated modules and said modules are: an inlet module (2), a generator module (3), a distributor module (4) and an outlet module (5) interconnected to each other by external flanges provided in each module and through inlet bearing (M1) and outlet bearing (M2) disposed throughout a longitudinal shaft (E) aimed at transmitting a hydraulic turbine torque upstream to a generator rotor (7) that supports a crown-shaped piece with permanent magnets thus working as an electromagnetic rotor.

2. Improvements in electrical energy turbo-generator in accordance with claim 1, further comprising an outer tube first section, wherein said outer tube includes a wall (2a), flanges (2b) and (2c), and a water inlet hydro-dynamic housing (2d) installed in said inlet module (2).

3. Improvements in electrical energy turbo-generator in accordance with claim 2, wherein said housing (2) is made of a resistant material and shaped as an ogive to decrease charge loss and decrease turbulence in a water-flow (F) towards a hydraulic turbine (8) rotor assembled in said shaft (E).

4. Improvements in electrical energy turbo-generator in accordance with claim 1, characterized in that said inlet bearing (M1) supports said electromagnetic rotor set (7) downstream that is provided between said inlet module (M2) and said generator module (3), said inlet bearing maintained alignment relative to a hydraulic rotor assembled set (8) located upstream; said bearing (M1) central portion is sealed by a sealing cover (T1) whereof said shaft (E) end is assembled.

5. Improvements in electrical energy turbo-generator in accordance with claim 4, characterized in that said hydraulic rotor (8) for conversion of fluid-dynamic energy is one of type Kaplan or propeller.

6. Improvements in electrical energy turbo-generator in accordance with claim 1, wherein shaft (E) is made of a single piece of material.

7. Improvements in electrical energy turbo-generator in accordance with claim 1, wherein shaft (E) is made into divided interconnected sections.

8. Improvements in electrical energy turbo-generator in accordance with claim 1, characterized in that said generator rotor (7) set magnetization is carried out by permanent magnet poles.

9. Improvements in electrical energy turbo-generator in accordance with claim 1, characterized in that said generator module (3) comprises outer tube second section having a wall (3a) and flanges (3b) and (3c) made of a resistant material; a smaller diameter tube (3d) made of said resistant material is provided in an inner portion of said tube (3) whereof smaller diameter tube (3d) is concentrically disposed relative to said tube (3a) by means of structural winglets (3e), said winglets longitudinally disposed with inlet grooves (3e′) and outlet grooves (3e″); said generator rotor (7), said generator module (3) reinforcing and securing a collar (9), stator securing ring (10), permanent magnets synchronous generator (12), and stator (11) are assembled into inner portion of said tube (3d).

10. Improvements in electrical energy turbo-generator in accordance with claim 9, characterized in that said two concentric structures (3a) and (3d) maintain said permanent magnets electrical generator (12) encapsulated, said encapsulated permanent magnets electrical generator (12) operating with a positive pressure relative to water running between said two concentric structures.

11. Improvements in electrical energy turbo-generator in accordance with claim 9, characterized in that said generator module (3) is provided with one or more tubes (13) serving as way out for electrical wires and monitoring cables, said tubes (13) communicating with said generator (12) by means of a channel (3f) made into one or more winglets (3e).

12. Improvements in electrical energy turbo-generator in accordance with claim 1, characterized in that said rotor (7) remains immersed into an oil bed.

13. Improvements in electrical energy turbo-generator in accordance with claim 1, characterized in that said distributor module (4) comprises installation of turbine (1) third section, said distributor module (4) comprising an outer tube (4a) with end flanges (4b) and (4c) supporting said hydraulic turbine pre-distributor device (14), said pre-distributor provided with fixed or moveable blades (14a) depending on pre-distributor device (14) application.

14. Improvements in electrical energy turbo-generator in accordance with claim 13, characterized in that outlet bearing (M2) supporting electromagnetic rotor (7) upstream is assembled in a central portion of said pre-distributor device (14), said outlet bearing playing a role to support axial forces actuating on said shaft (E) portion; additionally, said outlet bearing (M2) aligns electromagnetic rotor set (7) with hydraulic rotor assembled set (8).

15. Improvements in electrical energy turbo-generator in accordance with claim 1, characterized in that said outlet module (5) comprises a fourth section of installation and yet comprises an outer tube segment (5a) with end flanges (5b) and (5c), whereof said tube (5a) concentrically accommodates a hydraulic rotor (8); said hydraulic rotor external diameter being compatible with pre-distributor device (14), central collar (14b), and also with the diameter of water outlet housing (15), said housing (15) molded so as to allow water to run back into water stream by means of an outlet flow (F2) with less possible turbulence and charge loss.

16. Improvements in electrical energy turbo-generator in accordance with claim 1, further comprising a conversion module (6) integrated with said generator (12) to convert frequency and tension regulation.

17. Improvements in electrical energy turbo-generator in accordance with claim 1, further comprising said turbo-generator (1) installed in a small central hydroelectric power plant, mini central hydroelectric power plant, micro central hydroelectric power plant, or peak central hydroelectric power plant.

18. Improvements in electrical energy turbo-generator in accordance with claim 1, further comprising said turbo-generator (1) directly installed in a water storage dam as a single unitary set or as a set with more than one single module.

19. Improvements in electrical energy turbo-generator in accordance with claim 1, further comprising a hydraulic rotor (8) being a Kaplan or propeller directly connected by to said permanent magnets synchronous generator rotor (12) to eliminate speed reduction or speed increasing systems.

20. Improvements in electrical energy turbo-generator in accordance with claim 1, further comprising said turbo-generator (1) modular arrangement operable without varying direction of water-flow, named straight-flow, and may operate either horizontally or at any other inclination.

21. Improvements in electrical energy turbo-generator in accordance with claim 1, further comprising said turbo generator (1) modular arrangement operable without the need of a heat-sink.
